(19) United States
(12) Patent Application Publication
(10) Pub. No.: US 2025/0323031 A1
(43) Pub. Date: Oct. 16, 2025

(54) Ion Beam Electron Transfer Dissociation

(71) Applicant: DH Technologies Development Pte. Ltd., Singapore (SG)

(72) Inventors: Takashi BABA, Richmond Hill (CA); Kaoru KARASAWA, Tokyo (JP)

(21) Appl. No.: 18/870,121

(22) PCT Filed: May 26, 2023
(86) PCT No.: PCT/IB2023/055444

§ 371 Date: Nov. 27, 2024

Related U.S. Application Data
(60) Provisional application No. 63/347,795, filed on Jun. 1, 2022.

(51) Int. Cl. H01J 49/00; H01J 49/42

(52) U.S. Cl. CPC H01J 49/0072; H01J 49/4225

(57) ABSTRACT

A method of dissociating an analyte in a mass spectrometer includes ionizing the analyte to generate a plurality of ions of the analyte, introducing and trapping the analyte ions into an ion trap, using an electron source to generate electrons, introducing a gas comprising a reagent molecule into a region between the electron source and a gate electrode, and using the gate electrode to cause ionization of the reagent molecules thereby generating a plurality of ions of the reagent molecule. The electron source inhibits entry of the accelerated electrons into the ion trap, the gate electrode is maintained at an electric potential to accelerate the reagent ions for entry into the ion trap as a positively charged ion beam, and the ion beam causes negative electron transfer dissociation of at least a portion of the analyte ions.

### RELATED APPLICATIONS

This application claims priority to U.S. provisional application No. 63/347,795 filed on Jun. 1, 2022, entitled “Ion Beam Electron Transfer Dissociation,” which is incorporated herein by reference in its entirety.

### TECHNICAL FIELD

The following generally relates to a mass spectrometer and more particularly to a mass spectrometer utilizing negative electron transfer dissociation (ETD) for mass analysis of compounds.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis. Generally, a mass spectrometer includes an ion source, an analyzer, and a detector. The ion source converts a test sample into gaseous ions, the mass analyzer separates the gaseous ions based on their m/z ratios, and the detector detects the separated ions. One or more isolation devices are often inserted between the ion source and the mass analyzer. One or more dissociation device are often installed between the isolation devices and the mass analyzer.

A mass spectrometer can employ dissociation to cause the fragmentation of large analytes (e.g., oligonucleotides, DNA, RNA, etc.) into smaller fragment ions. These smaller fragment ions can then be mass analyzed and quantified based on their m/z ratios. In the cases of oligonucleotides, this group of molecules are ionized in negative mode to generate negatively charged ions, i.e., deprotonated oligonucleotides. For deprotonated oligonucleotides, electron detachment dissociation (EDD), negative electron transfer dissociation (ETD) and electron photodetachment dissociation (EPD) have been explored to sequence oligonucleotides.

### SUMMARY

Aspects of the present disclosure address the above-referenced problems and/or others.

In one aspect, a method of dissociating an analyte in mass spectrometric analysis includes ionizing the analyte to generate a plurality of negatively charged ions of the analyte (also referred to as “precursor ions” herein), introducing and trapping the negatively charged analyte ions in an ion trap positioned in a chamber of the mass spectrometer, using an electron source external to the ion trap to generate electrons, introducing a gas comprising a reagent molecule into a region between the electron source and a gate electrode positioned downstream from the electron source and configured for application of a DC voltage thereto for establishing an electric field between the electron source and the gate electrode for accelerating the electrons to a kinetic energy sufficient for causing ionization of the reagent molecules, thereby generating a plurality of positively charged ions of the reagent molecules. The electron source is maintained at an electric potential relative to the ion trap to inhibit entry of the accelerated electrons into the ion trap while the positively charged reagent ions enter the ion trap as an ion beam to interact with the negatively charged analyte ions so as to cause negative electron transfer dissociation (nETD) of at least a portion of the negatively charged analyte ions.

In some embodiments, a pole electrode is positioned downstream of the gate electrode and maintained at a potential difference relative to the gate electrode so as to provide a potential barrier that inhibits passage of the electrons into the ion trap while facilitating the introduction of the positively charged reagent ions into the ion trap. By way of example, the pole electrode can be maintained at a voltage in a range of about −2V to about −20 V relative to the gate electrode. Further, the voltage applied to the pole electrode relative to the ion trap (e.g., the rods of the ion trap) can inhibit the leakage of negative analyte ions and product ions out of the ion trap. In some embodiments, the gate electrode is maintained at a potential in a range of about +50 volts to about +100 volts and the electron source is maintained at a voltage of about +10 volts relative to said ion trap as a default setting; however, the electron source can be maintained at a voltage in range of about +10 volts to about +50 volts relative to said ion trap in some embodiments.

In some embodiments, the reagent ions comprise any of nitrogen ions, helium ions, neon ions, argon ions, and krypton ions. The nitrogen molecular ion can comprise N₂⁴, the helium ion can comprise Het, the argon ion can comprise Ar⁺, the neon ion can comprise N⁺ and the krypton ion can comprise Kr⁺.

In some embodiments, the ion trap can include a radio frequency (RF) ion trap and the RF ion trap is configured such that the negatively charged analyte ions are within a stability region of the RF ion trap and the positively charged reagent ions can be outside the stability region of the RF ion trap. In some such embodiments, the RF ion trap can include a branched RF ion trap.

In another aspect, an ion dissociation device for use in a mass spectrometer includes a chamber having an input port configured to receive a gas containing a reagent molecule, an electron source for generating electrons, a gate electrode positioned relative to the electron source and maintained at a positive electrical potential relative to the electron source so as to accelerate the electrons to a kinetic energy sufficient to cause electron impact ionization of the reagent molecule, thereby generating a reagent ion. To stop the generation of the reagent ions, the gate potential may be set at a negative value relative to the electron source. A reaction device can include a first pathway for receiving an analyte ion and a second pathway for receiving the reagent ion, wherein the reaction device further includes an ion trap that traps the analyte ion such that the analyte ion can react with the reagent ion to undergo nETD, thereby generating a plurality of fragment ions. The gate electrode can be maintained at an electric potential relative to the electron source so as to cause acceleration of the emitted electrons to impart sufficient energy to the electrons for causing ionization of the reagent ions, and a pole electrode positioned between the gate electrode and an inlet of the ion trap can be maintained at a potential relative to the gate electrode to provide a potential barrier for the electrons so as to inhibit the passage of the electrons into the ion trap. More specifically, an electric field established between the gate electrode and the pole electrode can repel the electrons back towards the gate electrode while providing an attractive force for facilitating the introduction of the positively charged reagent ions into the ion trap.

In some embodiments, the analyte ion is negatively charged and the reagent ion is positively charged. The ion dissociation device can include a lens electrode positioned in proximity of a distal opening of the second pathway, wherein the lens electrode is maintained at a negative potential relative to the ion trap to inhibit leakage of the trapped negatively charged analyte ions out of the ion trap. In some embodiments, at least a portion of the fragment ions exit the ion trap via the first pathway and at least a portion of the ion beam exits the ion trap via the second pathway. In some embodiments, the ion trap can be a radio frequency (RF) ion trap. By way of example, in some such embodiments, the RF ion trap can be a branched RF ion trap. Such a branched RF ion trap can include two sets of L-shaped electrodes that are axially separated from another, wherein each set of the L-shaped electrodes comprises four electrodes arranged in a quadrupole configuration, though in other embodiments other multipole configurations may also be employed. In some embodiments an RF voltage source can be employed to apply RF voltages to each set of L-shaped electrodes to generate a quadrupolar electric RF field in the space between electrodes. In some embodiments, an ion dissociation device can include a magnet configured to generate a magnetic field extending from the electron source to the gate electrode to provide confinement of the emitted electrons and facilitate their transfer from the electron source (e.g., a thermally activated filament) to the gate electrode.

In yet another aspect, a mass spectrometer includes an ion dissociation device having a chamber. The chamber can include an input port configured to receive a gas containing a reagent molecule, an electron source for generating electrons, a gate electrode relative to the electron source and maintained at a positive electrical potential relative to the electron source so as to accelerate the electrons to a kinetic energy sufficient to cause electron impact ionization of the reagent molecule thereby generating a reagent ion, a reaction device having a first pathway for receiving an analyte ion and a second pathway for receiving a reagent ion, wherein the reaction device further includes an ion trap that traps the analyte ion and the reagent ion such that the reagent ion can interact with the analyte ion in the ion trap to cause nETD of the reagent ion thereby generating a plurality of fragment ions. The electron source can be maintained at an electric potential relative to the ion trap to inhibit entry of the accelerated electrons into the ion trap while accelerating the reagent ions for entry into the ion trap via the second pathway as an ion beam.

In some embodiments, the analyte ion can be negatively charged and the reagent ion can be positively charged. In some embodiments, the mass spectrometer further includes a lens electrode positioned in proximity to a distal opening of the second pathway, wherein the lens electrode is maintained at a negative potential relative to the ion trap to inhibit leakage of the trapped negatively charged analyte ions and fragment ions out of the ion trap. At least a portion of the fragment ions can exit the ion trap via the first pathway and at least a portion of the ion beam can exit the ion trap via the second pathway. In some embodiments, the ion trap can be a radio frequency (RF) ion trap. The RF ion trap can be a branched RF ion trap that includes two sets of L-shaped electrodes axially separated from another, wherein each of the sets of the L-shaped electrodes comprises four electrodes arranged in a quadrupole configuration. In some embodiments, the mass spectrometer can further include an RF voltage source for applying RF voltages to each set of L-shaped electrodes to generate a quadrupolar electric RF field between electrodes.

### BRIEF DESCRIPTION OF THE DRAWINGS

Aspects of the present disclosure may take form in various components and arrangements of components, and in various steps and arrangements of steps. The drawings are only for illustration purpose of preferred embodiments of the present disclosure and are not to be considered as limiting.

Features of embodiments of the present disclosure will be more readily understood from the following detailed description take in conjunction with the accompanying drawings in which:

FIG. 1 diagrammatically illustrates a mass spectrometer in accordance with an exemplary embodiment;

FIG. 2 depicts a plurality of electrons that interact with a plurality of positively charged reagent molecules in accordance with an exemplary embodiment;

FIGS. 3A-3D are graphs depicting differing fragmentation patterns of an analyte in accordance with an exemplary embodiment;

FIG. 4 is a flow chart of a method for dissociating an analyte in a mass spectrometer in accordance with an exemplary embodiment;

FIG. 5 is an exemplary nETD spectrum; and

FIG. 6 schematically depicts a computer system in accordance with an exemplary embodiment.

### DETAILED DESCRIPTION

As noted above, a mass spectrometer can employ negative electron transfer dissociation to fragment large analytes (e.g., oligonucleotides, DNA, RNA, etc.) into smaller fragment ions (e.g., fragments containing nucleotides). These smaller fragment ions can then be mass analyzed and quantified based on their m/z ratios.

Unfortunately, conventional mass spectrometers utilizing negative electron transfer dissociation for fragmenting analytes do not typically provide a sufficient sensitivity required for accurate interpretation of mass spectral data, especially for mass analysis of negatively charged large analytes (e.g., deprotonated oligonucleotides).

In one aspect, the present disclosure generally relates to methods for performing mass spectrometry and mass spectrometers that can be utilized to practice such methods in which a plurality of negatively charged ions of an analyte can be trapped in an ion trap and a beam of positively charged reagent ions can be introduced into the ion trap to react with the negatively charged analyte ions to cause their dissociation via negative electron transfer dissociation (nETD), where the beam of positively charged reagent ions can be generated via electron impact ionization of reagent molecules via a plurality of electrons that are emitted by a filament and accelerated by an electric field established between the filament and a downstream gate electrode. A pole electrode positioned between the gate electrode and an inlet of the ion trap can be maintained at a voltage relative to the gate electrode to inhibit the passage of the electrons into the ion trap. Because electron impact ionization is efficient for a typical buffer gas contained in the ion trap, e.g., nitrogen, and the buffer gas is abundant in the trap, the produced positively charged reagent ion beam can be strong enough to induce fast nETD of the analyte ions. In many embodiments, the positively charged reagent ions are too light relative to the negatively charged analyte ions such that mutual entrapment of both the positively charged reagent ions and the negatively charged analyte ions within the ion trap is not feasible. For example, the ion trap RF amplitudes at which the negatively charged analyte ions can be stably trapped within the ion trap may be too high for trapping the reagent ions. The use of a positively charged reagent ion beam that passes through a reaction region of the ion trap to interact with the negatively charged analyte ions can provide certain advantages, e.g., it can enhance the reaction rate of nETD using the stronger reagent beam than heavy reagent ions that could be mutually trapped with the negatively charged analyte ions.

Accordingly, the purpose of this disclosure is to provide an efficient ETD methods using positively charged ions in a beam. The positive ion beam induces electron transfer from the deprotonated oligonucleotides to the positive ions, which introduces unpaired (or radical) electrons in the oligonucleotides, which makes the molecules unstable, which results in fragmentation.

As used herein, the term “about” means plus or minus 10% of the numerical value of the number with which it is being used. Therefore, about 100 μm means in the range of 90 μm-110 μm.

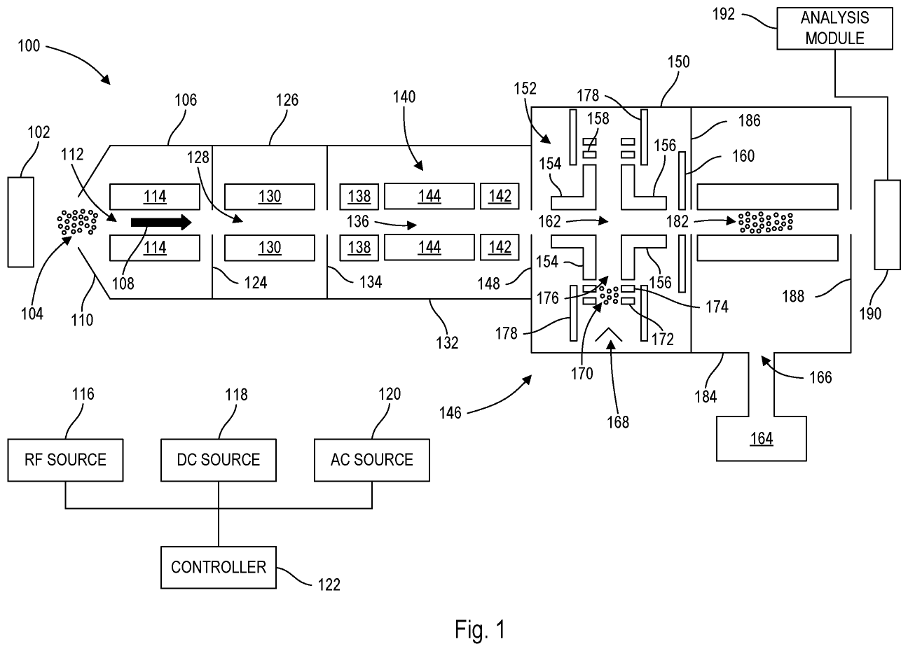

FIG. 1 schematically depicts a mass spectrometer 100 in accordance with an exemplary embodiment. In this embodiment, the mass spectrometer 100 includes an electrospray ion source 102 that generates a plurality of negatively charged analyte ions 104 (e.g., oligonucleotide ions). The ion source 102 is in communication with a sample holder (not shown) which provides analytes to the ion source 102. The mass spectrometer 100 also includes a vacuum chamber 106 that is in open communication with the ion source 102. The charged analyte ions 104 travel in the direction of arrow 108 and pass through an aperture of a curtain plate 110 to enter the vacuum chamber 106.

Once within the vacuum chamber 106, the charged analyte ions 104 pass through an ion optic QJet (ion guide) region 112 that is disposed within the vacuum chamber 106. The QJet region 112 includes a plurality of rods 114, which are arranged in a quadrupole configuration in this embodiment.

The mass spectrometer 100 further includes an RF voltage source 116, a DC voltage source 118, and an AC voltage source 120 that are each under operation of a controller 122. The RF voltage source 116 can apply RF voltages to the rods 114 so as to generate an RF field. The RF field, in combination with gas dynamics, can focus the charged analyte ions 104 into an ion beam for transmission to downstream components of the mass spectrometer.

The charged analyte ions 104 pass through the QJet region 112 and are further focused by an IQ0 lens 124 and enter a vacuum chamber 126. The charged analyte ions 104 continue in the direction of arrow 108 and pass through a Q0 region 128. The Q0 region 128 includes an ion guide. In this embodiment, the ion guide includes four rods 130 arranged in a quadrupole configuration. The RF voltage source 116 is electrically connected to the rods 130 and supplies RF voltages to the rods 130 so as to generate an RF field for providing radial confinement of the ions 104 in proximity of the central axis of the rods 130.

The charged analyte ions 104 continue propagating in the direction of arrow 108 and enter a vacuum chamber 132 via an IQ1 ion lens 134. Once within the vacuum chamber 132, the charged analyte ions 104 pass through a Q1 region 136 that is disposed within the vacuum chamber 132. The Q1 region 136 includes a Brubaker lens (or stubby lens) 138, a mass filter 140, and a stubby lens 142. The stubby lens 138 is positioned upstream from the mass filter 140 and the stubby lens 142 is positioned downstream form the mass filter 140. The mass filter 140 includes a plurality of rods 144 that are arranged in a multipole configuration. More specifically, in this embodiment, the mass filter 140 includes four rods 144 arranged in a quadrupole configuration. The stubby lens 138 focuses charged analyte ions 104 exiting the vacuum chamber 126 into the mass filter 140.

The RF voltage source 116 provides RF voltages to the rods 144 and the DC voltage source 118 provides resolving DC voltages to the rods 144 of the mass filter 140. These voltages provide radial confinement of the ions 104 and further allows selecting ions 104 with a target m/z ratio or allows selecting ions 104 within a target range of m/z ratios to pass through the mass filter 140. After passing through the mass filter 140 the ions 104 are focused by the stubby lens 142 into a dissociation device 146 that is positioned downstream from the chamber 132. The ions 104 enter the dissociation device 146 via an IQ2 lens 148 that further focuses the charge analyte ions 104.

The dissociation device 146 includes a chamber 150 in which an ion trap 152 is disposed. The ion trap 152 is defined by first L-shaped electrodes 154 and second L-shaped electrodes 156 (also referred to as L-shaped rods 154 and 156 respectively) that are axially separated from one another, an electrode 158 (e.g., a lens electrode), and optionally an electrode 160. At the center of the ion trap 152 is reaction region 162. While FIG. 1 shows the mass spectrometer 100 as including the electrode 160, in other embodiments the electrode 160 may be omitted.

In this embodiment, the first L-shaped electrodes 154 and second L-shaped electrodes 156 include four electrodes (only two of which are shown in FIG. 1) that are arranged in a quadrupole configuration and are axially separated from one another to provide the ion reaction region 162 therebetween. The first L-shaped electrodes 154 and second L-shaped electrodes 156 form an axial pathway (in the direction of arrow 108) through which the charged analyte ions 104 may pass through. Further, the arrangement of the first L-shaped electrodes 154 and second L-shaped electrodes 156 also forms a transverse pathway that is perpendicular to the axial pathway. The ion trap 152 formed by the first L-shaped electrodes 154 and second L-shaped electrodes 156 may be referred to as a “branched ion trap.”

The RF voltage source 116 and the DC voltage source 118 operating under control of the controller 122 supply voltages to the L-shaped electrodes 154 and 156 which trap the negatively charged analyte ions 104 within the ion trap 152. In embodiments, since the first L-shaped electrodes 154 and second L-shaped electrodes 156 are supplied with an RF voltage, the ion trap 152 may be referred to as a “branched RF ion trap.”

The electrode 158 and an electrode 174 are positioned in proximity of the openings of the transverse pathway defined by the first L-shaped electrodes 154 and second L-shaped electrodes 156. The DC voltage source 118 can be used to apply a DC voltage to the electrodes 158 and 174 so as to maintain the electrodes 158 and 174 at an electric potential that would inhibit the negatively charged analyte ions 104 (e.g., oligonucleotides) and product ions from leaking out of the ion trap 152 via the transverse pathway. Accordingly, the electrode 174 further defines the ion trap 152.

The mass spectrometer 100 includes a gas reservoir 164 that is in communication with the chamber 150. The gas reservoir 164 supplies a neutral buffer gas containing a reagent (e.g., neon, krypton, helium, nitrogen, argon, etc.) to the chamber 150 via an input port 166.

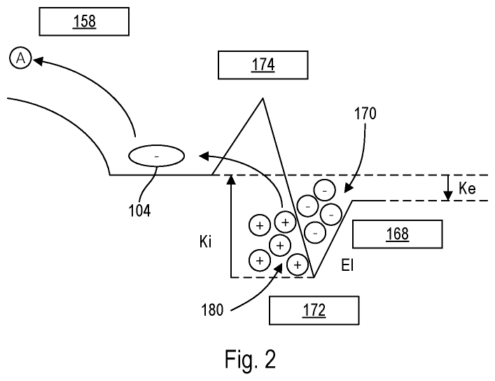

With reference to FIGS. 1 and 2, the mass spectrometer 100 also includes an electron source 168 (e.g., a filament) that generates a plurality of electrons 170, a gate electrode 172 and a pole electrode 174 that are positioned between the electron source 168 and an inlet 176. In this embodiment, the mass spectrometer 100 can further include magnets 178 that are configured to generate a magnetic field extending from the electron source 168 to the gate electrode 156 to confine the electrons 170.

The DC voltage source 118 operating under control of a the controller 122 can apply DC voltages to the gate electrode 172 and the pole electrode 174 such that the gate electrode 172 is positively biased relative to the electron source 168 and hence an electric field generated between the electron source 168 and the gate electrode 172 can accelerate the electrons 170 emitted by the electron source 168 to a sufficiently high kinetic energy suitable for ionization of the reagent molecules (e.g., via electron impact ionization (EI)), thereby generating a plurality of reagent ions 180 (e.g., N₂⁺, He⁺, Ne⁺, Kr⁺, Ar⁺etc.). By way of example, the voltage differential between the electron source 168 and the gate electrode 172 can be in a range of about +50 to +100 volts. In some such cases, the accelerated electrons 170 can acquire a kinetic energy greater than about 10 eV, e.g., in a range of about 10 eV to about 100 eV. The buffer gas contained in the gate region is ionized by electron impact to produce reagent ions 180. The reagent ions 180 are accelerated and introduced into the ion trap 152 as an ion beam via the inlet 176 of the transverse pathway. When generating the ion beam (when the ion beam is “on”) positively charged reagent ions 180 flow into the ion trap 152 and the gate is positively biased relative to the electron source 168, e.g., at about 95 V. When not generating the ion beam (when the ion beam is “off”) the gate electrode 172 is negatively biased relative to the electron source 168, e.g., at about −30 V.

The mutual entrapment of large negatively charged analyte ions 104 (e.g., negatively charged oligonucleotides) and small positively charged reagent ions 180 (e.g., N₂⁺) in the ion trap 152 is typically not feasible, e.g., due to significantly different requirements for RF voltages and/or frequencies. The present teachings overcome this difficulty by generating a beam of reagent ions that can pass through the ion trap 152 to interact with the negatively charged analyte ions 104 to cause their fragmentation via electron transfer dissociation.

The pole electrode 174 can be maintained at an electric potential relative to the gate electrode 172 so as to generate an electric field between the pole 174 and the gate electrode 172 for repelling the electrons 170, thereby confining the electrons 170 to the space between electron source 168 and the pole electrode 174. In other words, the voltage differential between the pole electrode 174 and the electron source 168 can generate a potential barrier that can inhibit the electrons 170 from entering the ion trap 152 and interacting with the analyte ions 104. By way of example, the potential difference between the gate electrode 172 and the electron source 168 can be in a range of about +30 volts to about +100 volts. Furthermore, the electron source 168 has a high potential (positively biased) than the ion trap 152. In some embodiments, the electron source 168 is maintained at a voltage that is more positive (e.g., about +10 V) than the ion trap 152

As noted above, in the ion trap 152, positively charged reagent ions 180 interact with the negatively charged analyte ions 104. During ion/ion interaction, one or more electrons may be transferred from a negatively charged analyte ion 104 (e.g., a negatively charged oligonucleotide ion) to a positively charged reagent ion 180. Electron transfer may result in a charge reduction in a range of 1 to typically 3. The electron transfer may cause at least a portion of the charged analyte ions 104 to fragment thereby generating a plurality of analyte fragment ions 182.

The present teachings allow adjusting the energy of the positively charged reagent beam that enters the ion trap 152 and causes electron transfer dissociation of the negatively charged analyte ions 104. For example, such a change in the energy of the reagent ion beam can be achieved via adjusting the gate bias voltage differential between about 15 V and about 100 V. Such a feature advantageously allows obtaining different fragmentation patterns of the analyte ions, as reagent beams with different energies can create different fragmentation patterns of the analyte ions.

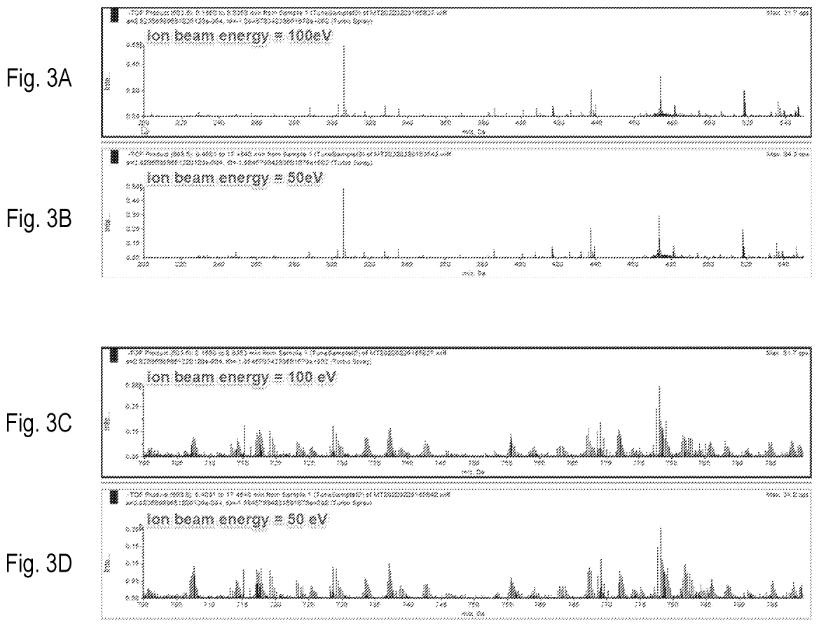

For example, as depicted in FIGS. 3A-3D, an ion beam with a higher energy causes a sample to fragment less relative to an ion beam with a lower energy. As such, the use of an energy beam around 50 eV may provide a more accurate fragmentation pattern of an oligonucleotide.

The pole electrode 174 is negatively biased relative to the ion trap 152, i.e., relative to the rods 154 and 156 of the ion trap 152, to ensure that the negatively charged ions cannot escape the ion trap through the inlet 176 while the positively charged reagent ions 180 can enter the ion trap 152 to interact with the negatively charged analyte ions 104. Accordingly, the pole electrode 174 further defines the ion trap 152. By way of example, the voltage differential between the pole electrode 174 and the ion trap can be in a range of about −5 V to about −20 V.

The inlet lens 148 is placed at the entrance of the ion trap 152. The lens 148 is biased negatively relative to the trap electrode 156. By way of example, the volage can be about −1 V when the precursor ions 104 are loading, and the voltage can be in a range of about −10 V to −30 V when the reagent beam is being applied. Again, by way of example, during ion beam application, the lens 148 voltage is set at about −1 V. In this setting, the negative analyte ions and the positive reagent ions are introduced simultaneously, which increases the duty cycle of the precursor consumption.

The electrode 160 is positioned in proximity of an axial outlet of the ion trap 152. Negative DC voltage is applied as the first step to confine all precursor and fragment ions in the ion trap 152. After the reaction period, the bias is set at zero to positive to extract the products from the ion trap 152. In another embodiment, the AC voltage source 120 supplies an AC voltage to the electrode 160 which generates a pseudopotential barrier that contains the negatively charged analyte ions 104 within the ion trap 152. However, fragment ions of interest (e.g., fragment ions having a certain m/z ratio) can overcome the AC pseudopotential barrier to enter a downstream Q2 collision cell 184 via an aperture of an IQ2 lens 186. In the collision cell, fragment ions 182 collide with buffer gas molecules supplied by the gas reservoir 164, where these collisions result in cooling of the fragment ions 182. The fragment ions 182 continue propagating in the direction of arrow 108 and exit the collision cell 184 via passage through an aperture of a lens 188. In some embodiments wherein the electrode 160 is omitted, the electrode 186 is opened after nETD reaction is applied.

The mass spectrometer 100 further includes a mass analyzer 190 (e.g., a time-of-flight (TOF) analyzer or another type of mass analyzer) positioned downstream from the collision cell 184 that receives the fragment ions 182 and provides mass spectral data associated with the fragment ions 182. An analysis module 192 receives the mass spectral data generated by the mass analyzer 190 and processes the data to generate a mass spectrum of the fragment ions 182 and correlates the mass spectrum of the fragment ions 182 with negatively charged analyte ions 104 from which the fragment ions 182 were generated.

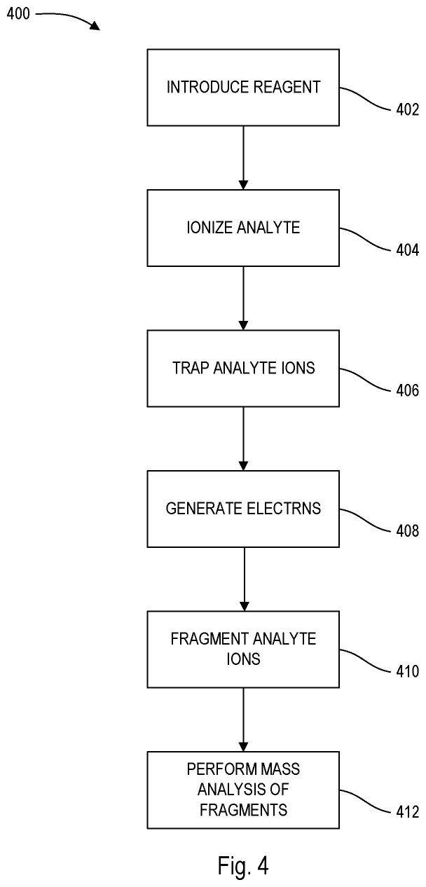

Referring now to FIG. 4 a method 400 of dissociating an analyte in a mass spectrometer is shown in accordance with an exemplary embodiment.

At 402, a gas comprising a reagent molecule is introduced into a region between the electron source and a gate electrode as previously discussed herein.

At 404, an analyte, e.g., an oligonucleotide, is ionized by the ion source to generate a plurality of negatively charged ions of the analyte as previously discussed herein.

At 406, the negatively charged analyte ions are introduced and trapped in an ion trap positioned in a chamber of the mass spectrometer as previously discussed herein, where the chamber contains a neutral buffer gas, e.g., nitrogen.

At 408, an electron source, e.g., a thermal filament, external to the ion trap generates electrons as previously discussed herein.

At 410, the electrons are accelerated via an electric field established via a potential difference between the filament and the gate electrode to a kinetic energy that is sufficient for causing ionization of the reagent molecules, thereby generating a plurality of positively charged ions of the reagent molecule as previously discussed herein. The accelerated electrons are inhibited from entering the ion trap, e.g., by repelling the accelerated electrons back towards the gate electrode, e.g., by establishing an appropriate voltage differential between a pole electrode and the gate electrode.

The positively charged reagent ions are introduced into the ion trap to interact with the negatively charged analyte ions for causing electron transfer from the negatively charged analyte ions to the positively charged reagent ions in order to cause electron transfer dissociation of at least a portion of the negatively charged analyte ions, thereby generating a plurality of fragment ions.

At 412, a mass analyzer receives the fragment ions and provide mass spectral data corresponding to m/z ratios of those ions.

At 414, the mass spectral data is analyzed so as to generate a mass spectrum of the fragment ions.

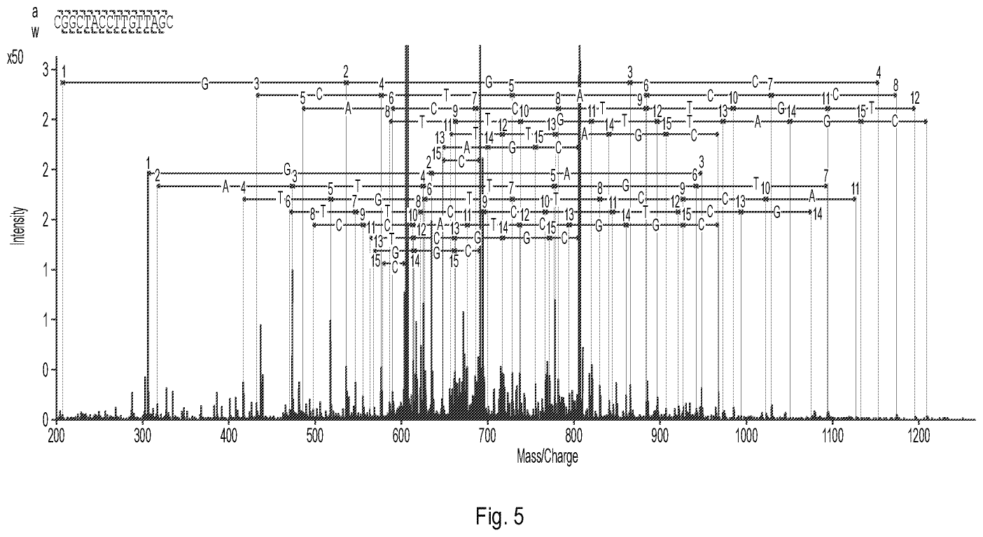

Referring now to FIG. 5, an example nETD spectrum generated using the methods disclosed herein is shown. In this example, a reagent ion beam (N₂⁺) having an energy of 60 eV was irradiated for 100 ms to a 16mer DNA. The DNA was sequenced with 100% coverage.

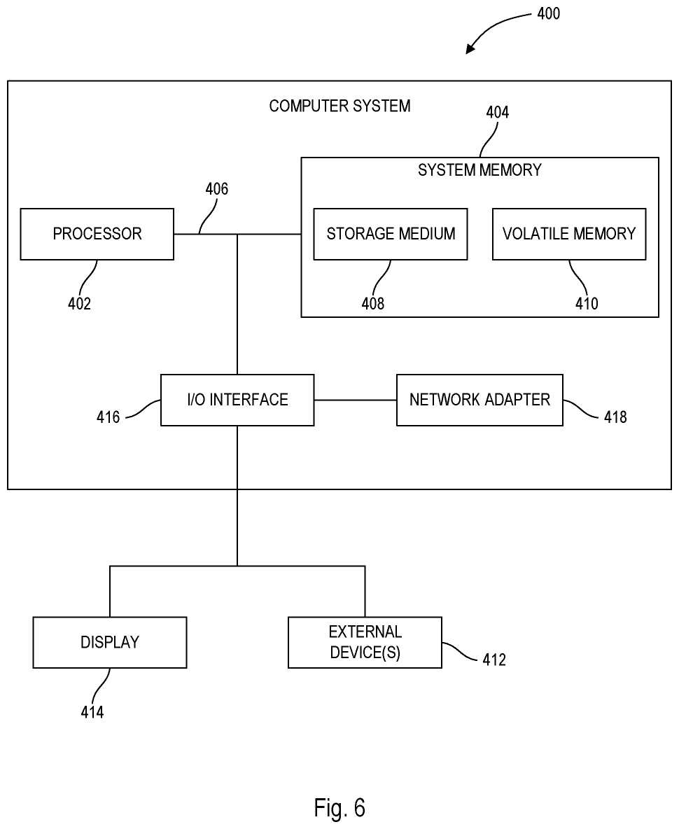

Referring now to FIG. 6, a computer system 600 is shown in accordance with an exemplary embodiment. In some embodiments, the computer system 600 serves as the controller 122.

As used herein a computer system (or device) is any system/device capable of receiving, processing, and/or sending data. Examples of computer systems include, but are not limited to personal computers, servers, hand-held computing devices, tablets, smart phones, multiprocessor-based systems, mainframe computer systems, and distributed cloud computing environments that include any of the above systems and the like

As shown in FIG. 6, the computer system 600 includes one or more processors or processing units 602, a system memory 604, and a bus 606 that couples various components of the computer system 600 including the system memory 604 to the processor 602.

The system memory 604 includes a computer readable storage medium 608 and volatile memory 610 (e.g., Random Access Memory, cache, etc.). As used herein, a computer readable storage medium includes any media that is capable of storing computer readable program instructions and is accessible by a computer system. The computer readable storage medium 608 includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the computer system 600) to function in a particular manner such that a computer readable storage medium (e.g., the computer readable storage medium 608) comprises an article of manufacture. Specifically, when the computer readable program instructions stored in the computer readable storage medium 608 are executed by the processor 602, they create means for implementing various functions described herein.

The bus 606 may be one or more of any type of bus structure capable of transmitting data between components of the computer system 600 (e.g., a memory bus, a memory controller, a peripheral bus, an accelerated graphics port, etc.).

In some embodiments, as depicted in FIG. 6, the computer system 600 may include one or more external devices 612 and a display 614. As used herein, an external device includes any device that allows a user to interact with a computer system (e.g., mouse, keyboard, touch screen, etc.). An external device 612 and the display 614 are in communication with the processor 602 and the system memory 604 via an Input/Output (I/O) interface 616.

The display 614 may show a graphical user interface (GUI) that may include a plurality of selectable icons and/or editable fields. A user may use an external device 612 (e.g., a mouse) to select one or more icons and/or edit one or more editable fields. Selecting an icon and/or editing a field may cause the processor 602 to execute computer readable program instructions stored in the computer readable storage medium 608. In one example, a user may use an external device 612 to interact with the computer system 600 and cause the processor 602 to execute computer readable program instructions relating to the various functions described herein.

The computer system 600 may further include a network adapter 618 which allows the computer system 600 to communicate with one or more other computer systems/devices via one or more networks (e.g., a local area network (LAN), a wide area network (WAN), a public network (the Internet), etc.).

While the invention has been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

What is claimed is:

1. A method of dissociating an analyte in a mass spectrometer, comprising:
ionizing the analyte to generate a plurality of negatively charged ions of the analyte;
introducing and trapping the negatively charged analyte ions in an ion trap positioned in a chamber of the mass spectrometer;
using an electron source external to the ion trap to generate electrons;
introducing a gas comprising a reagent molecule into a region between the electron source and a gate electrode, wherein the gate electrode is positioned relative to the electron source; and
using the gate electrode to accelerate the electrons to a kinetic energy sufficient for causing ionization of the reagent molecules thereby generating a plurality of positively charged ions of the reagent molecule,
wherein the electron source is maintained at an electric potential relative to the ion trap to inhibit entry of the accelerated electrons into the ion trap,
wherein the gate electrode is maintained at an electric potential to accelerate the positively charged reagent ions for entry into the ion trap as a positively charged ion beam, and
wherein the ion beam interacts with the negatively charged analyte ions in the ion trap to cause negative electron transfer dissociation (nETD) of at least a portion of the negatively charged analyte ions.

2. The method of claim 1, wherein the reagent ions comprise any of nitrogen molecular ions, helium ions, neon ions, and krypton ions.

3. The method of claim 2, wherein the nitrogen molecular ion comprises N₂⁺, the helium ion comprises He⁺, the neon ion comprises Ne⁺, the argon ion comprises AR⁺ and the krypton ion comprises Kr⁺.

4. The method any preceding of claim 1, wherein the gate electrode is maintained at a potential in a range of about +50 volts to about +100 volts relative to the electron source.

5. The method of claim 4, wherein the electron source is maintained at a voltage about +10 volts relative to said ion trap.

6. The method of claim 5, wherein the electron source is maintained at a voltage in range of about +10 volts to about +50 volts relative to said ion trap.

7. The method of any preceding claim 1, wherein the ion trap comprises a radio frequency (RF) ion trap.

8. The method of claim 7, wherein the RF ion trap is configured such that the negatively charged analyte ions are within a stability region of the RF ion trap and the positively charged reagent ions are outside a stability region of the RF ion trap.

9. The method of claim 7, wherein the RF ion trap is configured such that the negatively charged analyte ions and the positively charged reagent ions are within a stability region of the RF ion trap.

10. The method of claim 7, wherein the RF trap comprises a branched RF ion trap.

11. An ion dissociation device for use in a mass spectrometer, comprising:
a chamber that includes:
an input port configured to receive a gas containing a reagent molecule;
an electron source for generating electrons;
a gate electrode relative to the electron source and maintained at a positive electrical potential relative to the electron source so as to accelerate the electrons to a kinetic energy sufficient to cause electron impact ionization of the reagent molecule thereby generating a reagent ion; and
a reaction device having a first pathway for receiving analyte ion and a second pathway for receiving a regent ion, wherein the reaction device further includes an ion trap that traps the analyte ion and the reagent ion such that the reagent ion can interact with the analyte ion in the ion trap to cause negative electron transfer dissociation (nETD) of the reagent ion thereby generating a plurality of fragment ions,
wherein the electron source is maintained at an electric potential relative to the ion trap to inhibit entry of the accelerated electrons into the ion trap while the gate electrode is maintained at an electric potential that allows the reagent ions to enter the ion trap via the second pathway as an ion beam.

12. The ion dissociation device of claim 11, wherein the analyte ion is negatively charged and the reagent ion is positively charged.

13. The ion dissociation device of claim 11, further comprising:
a lens electrode positioned in proximity to a distal opening of the second pathway, wherein the lens electrode is maintained at a negative potential relative to the ion trap to inhibit leakage of the trapped negatively charged analyte ions out of the ion trap.

14. The ion dissociation device of claim 11, wherein at least a portion of the fragment ions exit the ion trap via the first pathway and at least a portion of the ion beam exits the ion trap via the second pathway.

15. The ion dissociation device of claim 11, wherein the RF ion trap is a branched radio frequency (RF) ion trap comprising two sets of L-shaped electrodes axially separated from another, wherein each of the sets of the L-shaped electrodes comprises four electrodes arranged in a quadrupole configuration and the ion dissociation device further comprises:
an RF voltage source for applying RF voltages to each set of L-shaped electrodes to generate a quadrupolar electric RF field between electrodes; and
a magnet configured to generate a magnetic field from the electron source to the gate electrode.

16. A mass spectrometer, comprising:
an ion dissociation device including a chamber, wherein the chamber includes:
an input port configured to receive a gas containing a reagent molecule;
an electron source for generating electrons;
a gate electrode relative to the electron source and maintained at a positive electrical potential relative to the electron source so as to accelerate the electrons to a kinetic energy sufficient to cause electron impact ionization of the reagent molecule thereby generating a reagent ion; and
a reaction device having a first pathway for receiving analyte ion and a second pathway for receiving a regent ion, wherein the reaction device further includes an ion trap that traps the analyte ion and the reagent ion such that the reagent ion can interact with the analyte ion in the ion trap to cause negative electron transfer dissociation (nETD) of the reagent ion thereby generating a plurality of fragment ions,
wherein the electron source is maintained at an electric potential relative to the ion trap to inhibit entry of the accelerated electrons into the ion trap while accelerating the reagent ions for entry into the ion trap via the second pathway as an ion beam.

17. The mass spectrometer of claim 16, wherein the analyte ion is negatively charged and the reagent ion is positively charged.

18. The mass spectrometer of claim 16, further comprising:
a lens electrode positioned in proximity to a distal opening of the second pathway, wherein the lens electrode is maintained at a negative potential relative to the ion trap to inhibit leakage of the trapped negatively charged analyte ions out of the ion trap.

19. The mass spectrometer of claim 16, wherein at least a portion of the fragment ions exit the ion trap via the first pathway and at least a portion of the ion beam exits the ion trap via the second pathway.

20. The mass spectrometer of claim 16, wherein the RF ion trap is a branched radio frequency (RF) ion trap comprising comprises two sets of L-shaped electrodes axially separated from another, wherein each of the sets of the L-shaped electrodes comprises four electrodes arranged in a quadrupole configuration and the mass spectrometer further comprises:
an RF voltage source for applying RF voltages to each set of L-shaped electrodes to generate a quadrupolar electric RF field between electrodes.
